(19) United States
(12) Patent Application Publication
(10) Pub. No.: US 2026/0169893 A1
(43) Pub. Date: Jun. 18, 2026

(54) DEVICE PERFORMANE ANALYSIS APPARATUS AND METHOD

(71) Applicant: SK hynix Inc., Icheon-si (KR)

(72) Inventor: Sang Wook NAM, Icheon-si (KR)

(21) Appl. No.: 19/177,184

(22) Filed: Apr. 11, 2025

(30) Foreign Application Priority Data
Dec. 16, 2024 (KR) 10-2024-0187148

(51) Int. Cl. G06F 11/3604; G06F 11/30; G06F 11/362

(52) U.S. Cl. CPC G06F 11/3612; G06F 11/302; G06F 11/362

(57) ABSTRACT

A device performance analysis apparatus includes: a status detector configured to acquire a first status identification number stored by an analysis code embedded in a software configured to drive a device based on a preset parameter; and a status output signal generator configured to output a first status output value corresponding to the first status identification number acquired by the status detector to the outside.

### CROSS-REFERENCE TO RELATED APPLICATION

This application claims the benefit of priority under 35 U.S.C. § 119(a) to Korean Patent Application No. 10-2024-0187148, filed with the Korean Intellectual Property Office on Dec. 16, 2024, the disclosure of which is incorporated herein by reference in its entirety.

### BACKGROUND

### Technical Field

Embodiments of the present disclosure relate to a device performance analysis apparatus and method, more particularly, an apparatus and a method for performance analysis and debugging of software executed in a device.

### Background of the Disclosure

ASICs (application-specific integrated circuits) or APs (application processors) are being developed to perform various purposes. ASICs or APs are integrated circuits made for specific applications and special functions of devices, and can be called custom semiconductors or SoCs (system-on-chips).

Devices such as ASICs or APs typically have a CPU core or processor inside, and run software or applications developed for specific purposes on the CPU or processor to perform specific functions as required.

It is essential to evaluate whether an ASIC or Ap properly performs all functions according to the performance requirements before it is actually sold. That is, when the developed software is executed on the CPU of the ASIC, it is essential to evaluate whether the required functions are implemented with the required performance or higher, and if the required functions are not implemented or the required performance is not achieved, it is also essential to debug which part of the software has the problem.

At this time, performance analysis may be based on simulation test results at the waveform level. It is necessary to find a function that serves as the reference for performance analysis from a series of functions flows and perform reverse calculation by fining repetitive patterns.

For that, the program counter (PC) pointed to by the CPU must be output to the outside to obtain a waveform, the corresponding program counter must be obtained from the waveform, each program counter must be found to indicate which part of the code binary, and the location of the found code binary must be found to indicate which functions and which point in the original code implemented in the upper-level programming language. However, that process usually takes a long time, and the higher the level of compilation optimization, the more difficult it is to compare it with the original code, so the time it takes to find the function point in the original code pointed to by the program counter may become even longer.

In addition, to meet the required performance, the performance analysis mentioned above needs to be performed repeatedly, which may increase the amount of time consumed.

### SUMMARY

Accordingly, one object of the present disclosure is to solve the above-noted disadvantages of the prior art, and embodiments of the present disclosure may provide an apparatus that may execute performance analysis quickly and intuitively, and a method thereof.

According to embodiments of the present disclosure, a device performance analysis apparatus may include a status detector configured to acquire a first status identification number stored by an analysis code embedded in a software configured to drive a device based on a preset parameter; and a status output signal generator configured to output a first status output value corresponding to the first status identification number acquired by the status detector to outside, wherein the first status output value is usable for analyzing or debugging performance of the device.

According to embodiments of the present, a device may include a processor configured to execute a software comprising an analysis code inserted into each of multiple positions within the software, with a status identification number as a parameter; and an analysis tool configured to analyze performance of the software executed on the processor. When the analysis code is executed, the processor is configured to store a first status identification number, which is a parameter of the executed analysis code, in a status storage, and the analysis tool is configured to acquire the first status identification number stored in the status storage and output a status output value corresponding to the first status identification number through an output terminal, wherein the first status output value is usable for analyzing or debugging performance of the device.

According to embodiments of the present disclosure, a performance analysis method of a device may include setting a parameter for performance analysis of the device; acquiring a first status identification number stored by an analysis code inserted in a software configured to drive the device based on the parameter; and outputting a first status output value corresponding to the first status identification number to outside, wherein the first status output value is usable for analyzing or debugging performance of the device.

According to the embodiments of the present disclosure, the location of the original code where the analysis code is inserted may be intuitively identified. Therefore, compared to the conventional methods, the analysis time may be significantly reduced.

Furthermore, according to the embodiments of the present disclosure, a series of operation periods may be expressed as one single status value. Therefore, it is possible to intuitively understand the operation of the chip just by looking at the change in the status values.

According to the embodiments of the present disclosure, developers or testers may directly specify the desired operation period. Therefore, performance analysis may be performed in various types depending on which period is specified with which status value.

### BRIEF DESCRIPTION OF DRAWINGS

FIG. 1 is a schematic diagram of a storage device according to embodiments of the present disclosure;

FIG. 2 is a diagram showing a performance analysis method of a software executed in a processor according to embodiments of the present disclosure;

FIG. 3 is a diagram showing exemplary code for analysis that is inserted into a specific location inside an analysis target software according to embodiments of the present disclosure.

FIGS. 4 to 7 are diagrams showing examples of setting different status in output values based on status identification numbers according to various embodiments of the present disclosure; and

FIG. 8 is a diagram showing a configuration of an analysis tool according to various embodiments of the present disclosure.

### DESCRIPTION OF SPECIFIC EMBODIMENTS

Description will now be given in detail according to exemplary embodiments disclosed herein, with reference to the accompanying drawings.

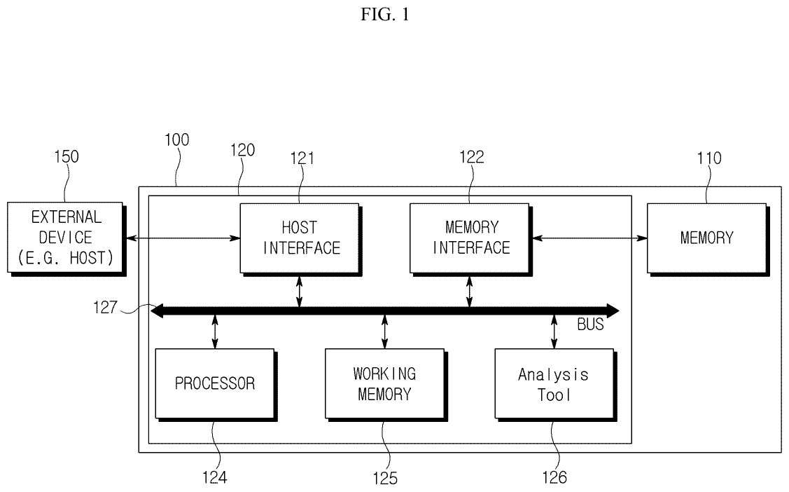

FIG. 1 is a schematic diagram of a storage device 100 according to embodiments of the present disclosure.

Referring to FIG. 1, the storage device 100 according to embodiments of the present disclosure may include a memory 110 configured to store data and a controller 120 configured to control the memory 110.

The memory 110 may be configured to operate in response to the control of the controller 120. Her, the operation of the memory 110 may include a read operation, a program operation (or write operation), and an erasure operation.

For example, the memory 110 may be implemented in various types such as DDR SDRAM (double data rate synchronous dynamic random access memory), LPDDR4 (low power double data rate4) SDRAM, GDDR (graphics double data rate) SDRAM, LPDDR (low power DDR), RDRAM (rambus dynamic random access memory), NAND flash memory, 3D NAND flash memory, NOR flash memory, resistive random access memory (RRAM), phase-change memory (PRAM), magnetoresistive random access memory (MRAM), ferroelectric random access memory (FRAM), or spin transfer torque random access memory (STT-RAM).

Meanwhile, the memory 110 may be implemented as a three-dimensional array structure. The embodiments of the present disclosure may be applied to a flash memory in which a charge storage is composed of a conductive floating gate, as well as a charge trap flash (CTF) in which a charge storage layer is composed of an insulating film.

The memory 110 may receive a command, an address, and etc. from the controller 120, and may access an area selected by the address among the memory cell arrays. That is, the memory 110 may execute an operation for the area selected by the address, which is indicated by the command.

For example, the memory 110 may be configured to perform a program operation, a read operation an erase operation, etc. In this regard, when performing a program operation, the memory 110 may program data in the area selected by the address. When performing a read operation, the memory 110 may read data from the area selected by the address. When performing an erase operation, the memory 110 may erase data stored in the area selected by the address.

The controller 120 may be configured to control a write (i.e., program) operation, a read operation, an erase operation, and a background operation for the memory 110. Here, as an example, a background operation may be garbage collection (GC), wear leveling (WL), read reclaim (RR), bad block management (BBM), hyper write migration, and SLC through migration, etc., and the embodiments are not limited thereto.

The controller 120 may control the operation of the memory 110 based on a request from an external device (e.g., host) located outside the storage device 100. On the other hand, the controller 120 may also control the operation of the memory 110 independently based on the request of an external device 150.

The external device 150 may be a computer, an ultra-mobile PC (UMPC), a workstation, a personal digital assistant (PDA), a tablet, a mobile phone, a smart phone, an e-book, a portable multimedia player (PMP), a portable game console, a navigation device, a black box, a digital camera, a DMB (digital multimedia broadcasting) player, a smart television, a digital audio recorder, a digital audio player, a digital picture recorder, a digital picture player, a digital video recorder, a digital video player, a storage constituting a data center, one of various electronic devices constituting a home network, one of various electronic devices constituting a computer network, one of various electronic devices constituting a telematics network, a radio frequency identification (RFID) device, a device that drives or operates on the ground, water or air under human control. Or it could be an autonomous mobile device (e.g. a car, robot, drone).

The external device 150 may include at least one operating system (OS). The operating system may be configured to manage and control the functions and operations of the external device as a whole, and provide interaction between the external device and the storage device 100.

Meanwhile, the controller 120 and the external device 150 may be separate devices. In some cases, the controller 120 and the external device 150 may be implemented as an integrated device. Below, for convenience of description, an example is given where the controller 120 and the external device 150 are separate devices.

Referring to FIG. 1, the controller 120 may include a host interface 121, a memory interface 122, a processor 120, a working memory 125, and it may further include an analysis tool 126.

The host interface 121 may be configured to provide an interface for communication with the external device 150. For example, the host interface 121 may provide an interface that uses at least one of various interface protocols, such as USB (universal serial bus) protocol, MMC (multimedia card) protocol, PCI (peripheral component interconnection) protocol, PCI-E (PCI-express) protocol, ATA (advanced technology attachment) protocol, serial-ATA protocol, parallel-ATA protocol, SCSI (small computer small interface) protocol, ESDI (enhanced small disk interface) protocol, IDE (integrated drive electronics) protocol, proprietary protocol, etc.

The memory interface 122 may be connected to the memory 110 and configured to provide an interface for communication with the memory 110. That is, the memory interface 122 may be configured to provide an interface between the memory 110 and the controller 120 in response to the control of the processor 124.

The working memory 125 may be configured to store firm ware, program codes, commands or data, which are required to drive the controller 120. The working memory 125 may include, for example, one or more of volatile memory such as statis RAM (SRAM), dynamic RAM (DRAM), and synchronous DRAM (SDRAM). According to embodiments, a portion of the working memory 125 may operate as a tightly coupled memory (TCM) and operate in close connection with the processor 124.

The analysis tool 126 is a device that can be used for operating performance and/or debugging of the controller 120. As shown in FIG. 1, the analysis tool 126 may be provided as separate hardware from the processor 124, but according to another embodiment, it may be implemented as software running on the processor 124. If the analysis tool 126 is implemented as software, the resources of the processor 124 is used, so additional performance degradation might occur. Therefore, the analysis tool 126 may be set to be activated only when analyzing the performance of the controller 120 and deactivated when the product is shipped and used normally.

The processor 124 may be configured to control the operation of the memory 110 by performing an overall control operation of the controller 120. The processor 124 may control all operations of the controller 120 and perform logical operations. The processor 124 may communicate with the external device through the host interface 121 and communicate with the memory 110 through the memory interface 122.

The processor 124 may perform the function of a flash translation layer (FTL). The processor 124 may convert a logical block address (LBA) provided by the host into a physical block address (PBA) through the flash translation layer (FTL). The flash translation layer (FTL) may use a mapping table in receiving an input of LBA and convert it into PBA.

There are several methods for address mapping in the flash translation layer depending on the mapping unit. Typical address mapping methods may include a page mapping method, a block mapping method, and a hybrid mapping method.

The processor 124 may randomize data received from the external device. For example, the processor 124 may randomize data received from the external device, using a preset randomizing seed. The randomized data may be provided to the memory 110 and programed in the memory cell of the memory 110.

The processor 124 may derandomize data received from the memory 110, when performing the read operation. For example, the processor 124 may derandomize data received from the memory 110, using a derandomizing seed. The derandomized data may be output to the external device.

According to an embodiment, the processor 124 may be an application specific integrated circuit (ASIC) in which the above-described functions are implemented in a logic form, and may control the operation of the controller 120 based on the functions implemented in the hardware.

According to another embodiment, the processor 124 may be a general-purpose processor or digital signaling processor (DSP) that can load and execute firmware to control the operation of the controller 120. In other words, the processor 124 may may execute (i.e., drive) the firmware loaded in the working memory 125 when control the overall operation of the controller 120 at boot time to perform logical operations.

For example, the firmware may include a flash translation layer (FTL) that performs a conversion function between a logical address requested from an external device to the storage device 100 and the physical address of the memory 110, a host interface layer (HIL) that interprets a command requested from the external device 150 to the storage device 100 and transmits it to the flash translation layer (FTL), and a flash interface layer (FIL) that transmits a command instructed by the flash translation layer (FTL) to the memory 110.

Such the firmware may be loaded in the working memory 125 from the memory 110 or a separate volatile memory (e.g., ROM, nor flash) located outside the memory 110. When executing a boot operation after power-on, the processor 124 may first load all or part of the firmware into the working memory 125.

The processor 124 may perform logical operations defined in the firmware loaded into the working memory 125 to control all operations of the controller 120. The processor 124 may store the result of performing the logical operations defined in the firmware in the working memory 125. The processor 124 may control the controller 120 to generate a command or signal based on the result of the logical operations defined in the firmware. If the portion of the firmware defining the logical operations to be performed is not loaded into the working memory 125, the processor 124 may generate an event (e.g., an interrupt) to load the corresponding portion of the firmware into the working memory 125.

Meanwhile, the processor 124 may load meta data required to drive the firmware from the memory 110. Meta data is data for manage the memory 110, and may include management information for user data stored in the memory 110, for example.

The firmware may be updated while the storage device 100 is being manufactured or running. The controller 120 may download new firmware from the outside of the storage device 100 and update the existing firmware with the new firmware.

The bus 127 may be configured to provide a channel between components 121, 122, 124, 125, and 126 of the controller 120. This bus 127 may include a control bus for transmitting various control signals, commands, etc., and a data bus for transmitting various data.

Meanwhile, some of the above-mentioned components 121, 122, 124, 125, and 126 may be deleted or integrated into on. In some cases, one or more other components may be added.

Referring to FIG. 1, it is described that the processor 124 may be implemented as one ASIC, and also the host interface 121, the memory interface 121, and the analysis tool 126 may be implemented as other ASICs, so they may be combined to be implemented as a SoC. At this time, each chip implemented as an ASIC may be called a device, and also an SoC implemented by combining them may be called a device as a single chip. In this instance, using the analysis tool 126, it is possible to analyze the performance of not only the software running on the processor 124 but also the software running on the CPU of the host interface 120 and the memory interface 122.

According to another embodiment, all of the host interface 121, the memory interface 122, the processor 124, and the analysis tool 126 may be implemented on one ASIC.

Alternatively, according to a further embodiment, the functions performed by the host interface 121, the memory interface, the processor 124, and the analysis tool 126 mentioned above may be implemented as software to be running on at least one processor.

Hereinafter, a method of analyzing the performance of the software running on the processor 124, the CPU of the host interface 121 or the CPU of the memory interface 122 by using the analysis tool 126 described above will be described in detail.

In the disclosure, it is described that the analysis tool is configured to analyze the performance of the software running in the controller 120 of the memory device, but it is obvious that the analysis tool should also be used to analyze the performance of software running on any CPUs.

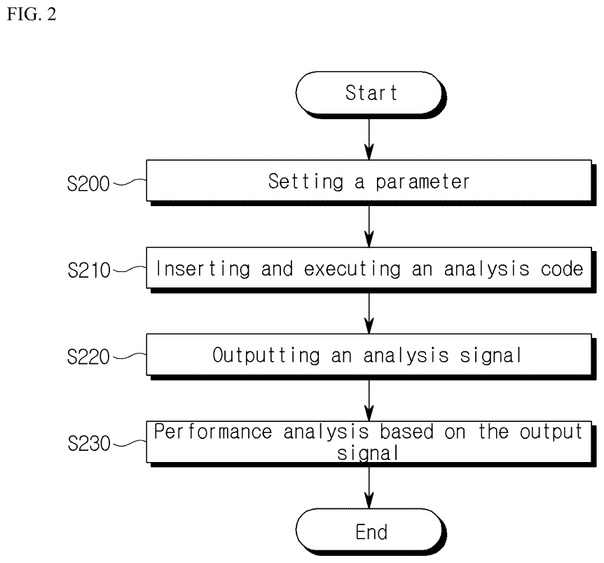

FIG. 2 is a diagram showing a performance analysis method of a software executed in a processor according to embodiments of the present disclosure.

Referring to FIG. 2, in an operation S200, a parameter for performance analysis may be set.

According to an embodiment, parameters for performance analysis may include a status storage and a status output value. The status storage may represent a memory area or memory areas and the status output value may be an output value of the status from the memory area. In addition, parameters for performance analysis may include the number of the number of the status identification numbers.

The status storage is a memory area where a code inserted into the software, which is an analysis target, will recode a status identification number. For example, the memory area may be a specific area of the working memory 125. According to an embodiment, for the faster access speeds, the status storage may be a TCM area connected to a TCM (tightly coupled memory) interface of the processor. According to other embodiments, the status storage may be a memory area embedded in a processor.

According to an embodiment, the status storage may be a memory area that may store only one status, but according to other embodiments, the status storage may be a memory area that may store a plurality of statuses. If the status storage is a memory area configured to store more than one status, then outputting a status stored in the status storage might become complicated.

An output value of the status may be a value that is output through an output terminal of the device based on a status stored in the status storage. The output value of the status may be any value that can be distinguished from other status values used in the analysis. Here, since setting an infinite number of distinct output values of the status is inefficient and may affect the performance of the software to be analyzed, the number of output values of the status that can be distinguished from each other needs to be limited. Accordingly, the number of the status identification numbers may be set as an additional parameter. The number of the status identification numbers may be the number of status identification numbers used as a parameter of analysis code that can be inserted into the software running on the processor for performance analysis. Each status identification number may be matched one-to-one with the location in the software code where the analysis code is inserted and used for performance analysis or debugging later.

According to an embodiment, if four output terminals of the SoC are used to output the output values of the status, then 16 distinct status output values of 0 (2′b0000) to 15 (2b′1111) may be output through the four output terminals. According to another embodiment, if one output terminal of the SoC is used to output the output values of the status, and three consecutive values are output as the status output values, then eight distinct status output values of 0 (2′b000) to 7 (2′b111) can be output through the three consecutive values. Alternatively, one output terminal of the SoC is used to output the output values of the status, and status output values may be output based on distinct signal wavelengths. That is, for status 1, a high level signal (which can be expressed as ‘H’ or ‘1’) with a 1-clock width may be output and for status 2, a high level signal with a 2-clock width may be output. The signal width output for each status may be set by the user. According to a still further embodiment, one output terminal of the SoC may be used to output the output values of the status, and the status output values may be output based on distinct signal sizes depending on the statuses. Accordingly, when the user monitors the signal output to the output terminal through an oscilloscope, etc., the user may intuitively recognize the status inserted in the software based on the output signal.

According to an embodiment, a parameter for performance analysis may include a polling cycle in which the analysis tool 126 polls the status stored in the status storage. A fast polling cycle can affect the performance of the software being analyzed, and a slow polling cycle can result in multiple changes in the status recoded in the status storage, which makes the analysis incorrect. Accordingly, the polling cycle may be determined based on the number of status identification numbers, or the minimum or average time interval between statuses written by the analysis code, inserted into the analysis target software in the status storage.

In an operation S210, a code for analysis may be inserted into a specific location within a software to be analyzed by the user, and may be running on the processor 124.

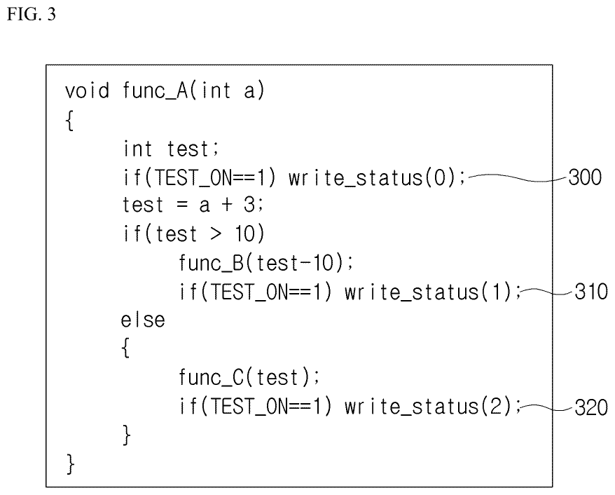

FIG. 3 is a diagram showing exemplary code for analysis that is inserted into a specific location inside an analysis target software according to embodiments of the present disclosure.

Referring to FIG. 3, in order to analyze the performance of a function func_A, which is a part of the software to be analyzed, an analysis code 300 for writing status 0 in a status storage may be inserted into a start position of func_A. An analysis code 310 for writing status 1 in the status storage may be inserted into an end position where the execution of func_B ends, and an analysis code 320 for writing status 2 in the status storage may be inserted into an end position where the execution of func_C ends.

When the analysis code is inserted, the processor 124 may use a resource for executing the analysis code, which could affect the performance of the software to be analyzed. Accordingly, the analysis code inserted into the software needs to have as little effect on the performance of the software as possible. Therefore, the analysis code write_status used in the example of FIG. 3 may be, as much as possible, the simplest function that does not use the resources of the processor 120.

Referring to the example of FIG. 3, an analysis tool 126 may additionally have a parameter ‘TEST_ON” to activate analysis testing. The analysis code may be coded to run only when the parameter “TEST_ON” is activated. According to an embodiment, when analysis of software is required, the analysis tool 126 may activate “TEST-ON” (set to 1) to allow the analysis code to be executed, and when analysis of the software is not performed and normal operation is desired, “TEST_ON” may be deactivated (set to 0).

According to another embodiment, the analysis tool 126 may determine whether the code analysis is activated for each status. For example, when the number of status identification numbers is 8, the analysis tool 126 may have a parameter of “TEST_ON[7:0], and when activating “TEST_ON[0]”, the analysis tool 126 may execute an analysis code for status 0. When deactivating “TEST_ON[1]”, it may not execute an analysis code for status 1.

Referring to FIG. 2, in an operation S210, code for software analysis may be inserted. When a corresponding software is executed on the processor 124, one of the multiple codes for analysis shown in FIG. 3 may be executed and then the corresponding code for analysis may write a status in the status storage. Referring to the example of FIG. 3, when func_A is executed and “TEST_ON” is activated, ‘0’ may be written in the status storage by “write_status (0). In FIG. 3, when “test” has a value equal to or smaller than 10, func_C( ) may be executed, and when the execution is completed, ‘2’ may be written in the status storage by “write_status(2)”. In FIG. 3, when “test” is greater than 10, func_B( ) may be executed, and after the execution of the function is completed, ‘1’ may be written in the status storage by “write_status(1)”. According to an embodiment shown in FIG. 3, when func_A is executed, ‘0’ may be written in the status storage based on the “test” value, and then ‘1’ or ‘0’ may be written in the status storage. After that, ‘2’ may be written.

Referring to FIG. 2, in an operation S220, the analysis tool 126 may output a status output value preset in response to each status to an output terminal of the SoC based on the status written in the status storage.

According to an embodiment, the analysis tool 126 may check a status stored in the status storage through a polling cycle. According to another embodiment, the analysis tool 126 may receive an interrupt generated if there is change in the status stored in the status storage, and may check the status stored in the status storage.

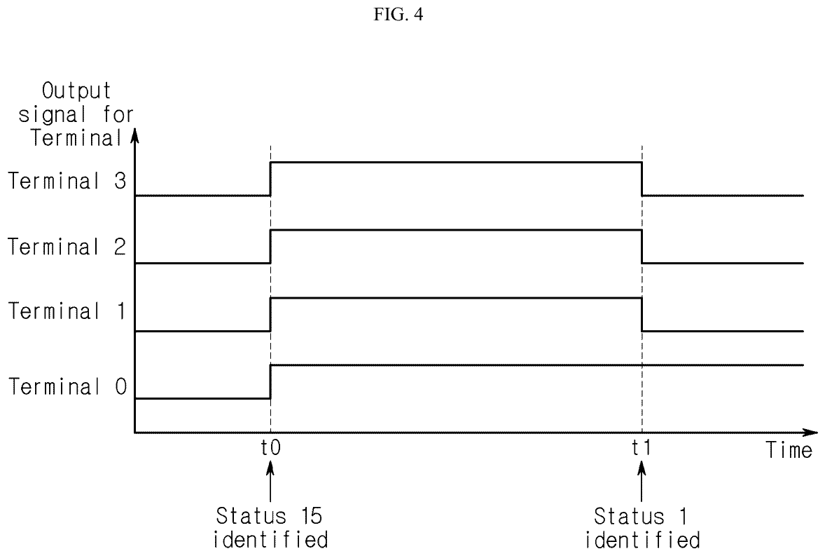

FIGS. 4 to 7 are diagrams showing examples of setting different status in output values based on status identification numbers according to various embodiments of the present disclosure. When checking a status stored in a status storage, an analysis tool 126 may output a status output value set in response to the checked status to an output terminal of an SoC.

As described above, the status output value that is output to the output terminal of the SoC by the analysis tool 126 may vary based on the number of output terminals used in outputting the status and a method of generating an output signal. For example, as shown in FIG. 4, if four output terminals are used and the analysis tool 126 may check that the status stored in the status storage is status 15 at a time t0, then the analysis tool 126 may output a high level signal to all four output terminals. Or, if checking that the status stored in the status storage is status 1 at a time t1, then the analysis tool 126 may output a high level signal to one (terminal 0) of the four output terminals and a low level signal (which may be indicated as ‘L’ or ‘0’) to the other three terminals (terminal 3, terminal 2, and terminal 1).

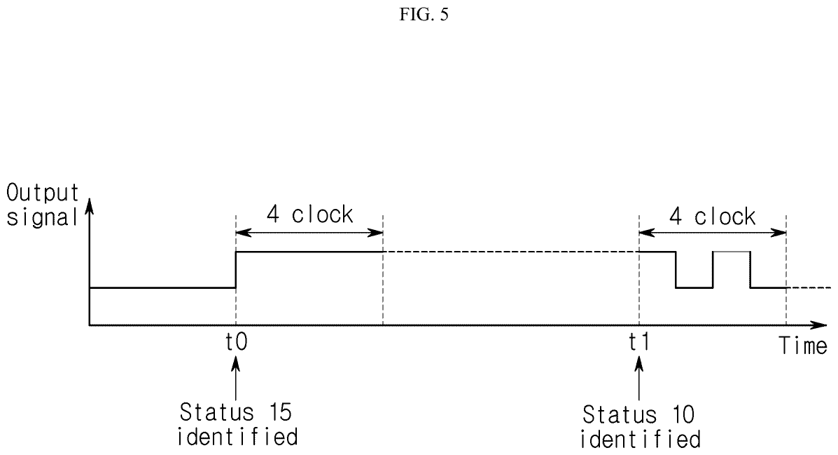

According to a further embodiment, as shown in FIG. 5, if one output terminal is used and the analysis tool 126 may check that the status stored in the status storage is status 15 at t0, then the analysis tool 126 may output a high level signal to the one output terminal for 4 clocks. Or, when the analysis tool 124 checks that the status stored in the status storage is status 10 at t1, then the analysis tool 126 may output a signal that transitions from high level to low level to high level to low level as clock toggles through the one output terminal.

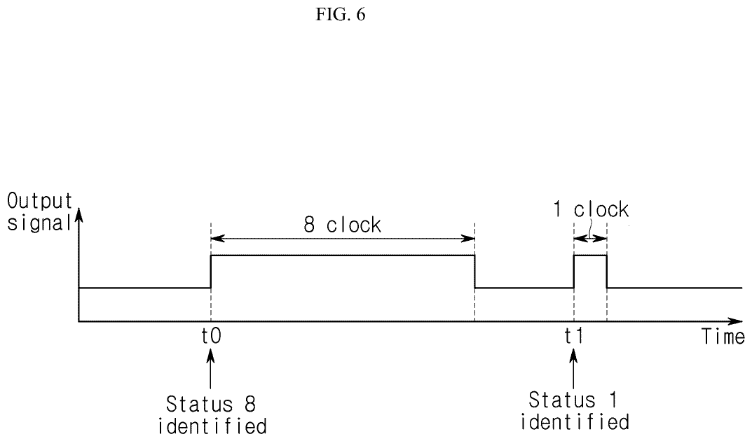

According to a still further embodiment, as shown in FIG. 6, when one output terminal is used and a signal is output with different signal widths depending on the status, the analysis tool 126 may check that the status stored in status storage is status 8 at time t0 and then it may output a high level signal for 8 clocks through one output terminal. Or, when checking that the status stored in the status storage is status 1, then the analysis tool 126 may output a high level signal to the one output terminal for 1 clock.

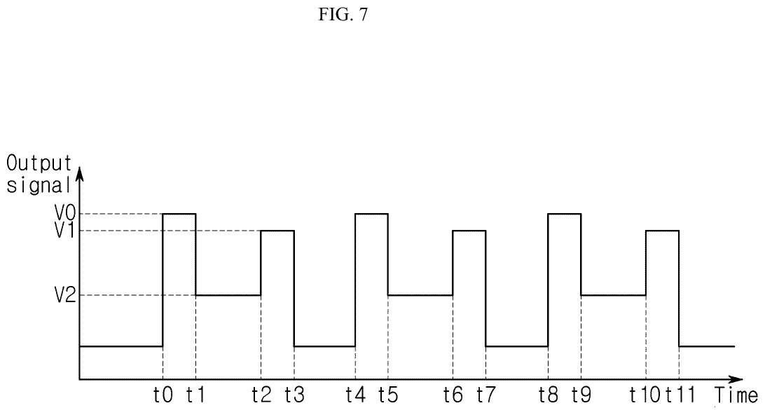

According to a still further embodiment, as shown in FIG. 7, if one output terminal is used and a signal is output with different signal sizes depending on the status, the analysis tool 126 may check that the status stored in the status storage is status 0 at t0 and then may output a voltage V0 to the one output terminal in response to the status 0. Or, if checking that the status stored in the status storage is status 6 at t1, the analysis tool 126 may output a voltage V2, preset in response to status 6, to the one output terminal. Or, if checking that the status stored in the status storage is status 1 at t2, the analysis tool 126 may output a voltage V1, preset in response to status 1, to the one output terminal.

As described above, the analysis tool 126 may output the output signals to the output terminal based on diverse methods preset for responding to the statuses stored in the status storage.

Referring to FIG. 2 again, performance analysis may be performed based on the signal output in an operation S230. According to an embodiment, in the operation S230, performance analysis may be performed by output signal analysis performed by the user. For example, when func_A shown in FIG. 3 is repeatedly performed, the analysis tool 126 may repeatedly output an output signal set corresponding to status 0 and an output signal set corresponding to status 1, or an output signal set corresponding to status 0 and an output signal set corresponding to status 2. Then, the time taken to execute the function func_B may be determined by measuring the time interval between the output signal set corresponding to status 0 and the output signal set corresponding to status 1. According to an embodiment, the time taken to execute func_B may vary with each measurement, as there are cases in which an interrupt occurs or a higher priority task must be performed first. Accordingly, the time taken to execute func_B may be determined as the average of the results of multiple measurements or the minimum of the results of multiple measurements.

Similarly, the time taken to execute func_C may be determined by measuring the time interval between the output signal set corresponding to status 0 and the output signal set corresponding to status 2. According to an embodiment, the time taken to execute func_C may be determined as the average of the results of multiple measurements or the minimum of the results of multiple measurements.

In addition, the analysis tool 126 may be configured to perform software code debugging in addition to performance analysis based on the output signal in the operation S230. For example, if func_A shown in FIG. 3 is executed normally, it is known that status 0->status 2->status 0->status 2->status 0->status 1->status 0″ should be output. However, if the output signal of the output terminal is analyzed and only “status 0->status 2->status 0->status 2->status 0->status 1” is output and the last status 0 is not output, then it is determined that an infinite loop is running in one of the software codes between the analysis code configured to write status 1 (write_status(1)) and the analysis code configured to write status 0 (write_status(0)), and the part with an error may be found and corrected.

The analysis tool 126 proposed in the present disclosure may perform software performance analysis, and especially, may also execute performance analysis on finely divided parts of the entire software such as modules or functions of the software. In addition, the analysis tool 126 may be effective in identifying the cause of a problem with the software.

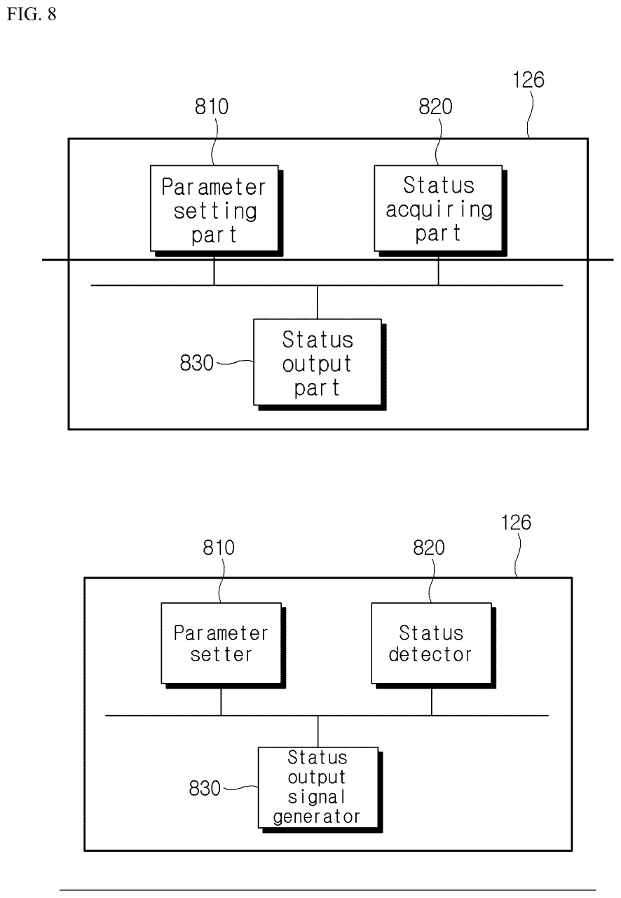

FIG. 8 is a diagram showing a configuration of an analysis tool according to various embodiments of the present disclosure.

An analysis tool 126 shown in FIG. 8 may be configured as a separate chip from the processor 124 shown in FIG. 1 and may operate separately. However, according to another embodiment, the analysis tool 126 may be manufactured as a software code and executed on the processor together with other software. Accordingly, each part shown in FIG. 8 may be a software module or function or a module implemented as hardware logic. If the analysis tool 126 is configured as a separate chip from the processor 124 and operates separately, it may be referred to as a device performance analysis apparatus as a separate apparatus.

Referring to FIG. 8, the analysis tool 126 may include a parameter setter 810, a status detector 820, and a status output signal generator 830.

The parameter setter 810 may be configured to set a parameter for software performance analysis. According to an embodiment, the parameter for performance analysis may include a status storage and a status in the form of an output value. Additionally, a parameter for performance analysis may include a status identification number value. The parameter setter 810 may be implemented as a processor. In addition, the operation of the parameter setter 810 may also be performed by the processor implementing the parameter setter.

The status storage is a memory area where a code inserted into a software, which is an analysis target, write a status identification number. For example, the memory area may be a specific memory area of a working memory 125, and according to an embodiment, for the faster connection speed, the status storage may be a TCM (tightly coupled memory) area connected to a TCM interface of the processor. According to another embodiment, the memory area may be an embedded memory area in the processor.

The output value of the status may be a status value that is output through an output terminal of an SoC based on a status stored in the status storage. The status output value may be any value, but only if the statuses used in the analysis can be distinguished from each other. Here, since setting an infinite number of distinct status output values is inefficient and may affect the performance of the software to be analyzed, the number of output values of the status that can be distinguished from each other needs to be limited. Accordingly, the number of the status identification numbers may be set as an additional parameter. The status identification numbers may be used as a parameter of analysis code that can be inserted into the software running on the processor for performance analysis. Each status identification number and the location in the software code where the analysis code is inserted may be matched in one-to-one correspondence, so that they may be used for performance analysis or debugging later.

Table 1 below shows various examples of setting output values of the status when the number of statuses is 8:

TABLE 1

| | | | Output of | | Output of |
|---|---|---|---|---|---|
| | | | a signal | | a signal |
| | Parallel | Continuous | with the | | with the |
| | output of the | output of the | following | | following |
| | following 3 | following 3 | widths by | | sizes by |
| | bits by using | bits by using | using one | | using one |
| | three output | one output | output | | output |
| Status | terminals bits | terminal | terminal | | terminal |
| number | (Example 1) | (Example 2) | (Example 3) | | (Example 4) |
| 0 | 000 | 000 | 1 | clock | 2.0 V |
| 1 | 001 | 001 | 2 | clocks | 1.8 V |
| 2 | 010 | 010 | 3 | clocks | 1.6 V |
| 3 | 011 | 011 | 4 | clocks | 1.4 V |
| 4 | 100 | 100 | 5 | clocks | 1.2 V |
| 5 | 101 | 101 | 6 | clocks | 1.0 V |
| 6 | 110 | 110 | 7 | clocks | 0.8 V |
| 7 | 111 | 111 | 8 | clocks | 0.6 V |

The status detector 820 may be configured to acquire a performance status by detecting the status from the status storage for the software currently being executed. the detecting operation may be a reading operation. When executed, the analysis code inserted in the software to be analyzed writes a status number given as a parameter from the status storage. For example, when an analysis code (write_status(a)) is executed, ‘a’ may be stored in the status storage. The status detector 820 may be implemented as a processor. In addition, the operation of the status detector 820 may also be performed by the processor implementing the parameter setter.

According to an embodiment, the status detector 820 may acquire the status numbers stored in the status storage by periodically reading the status storage.

According to another embodiment, the status detector 820 may acquire the status numbers stored in the status storage by reading the status storage based on an interrupt generated when a value of the status storage varies.

The status output signal generator 830 may be configured to generate an output signal which comprises an output value and output the output signal to the output terminal based on the status number acquired by the status detector 820, using the output value set by the parameter setter 810. The status output signal generator 830 may be implemented as a processor. In addition, the operation of the status output signal generator 830 may also be performed by the processor implementing the parameter setter.

According to an embodiment, if the status output value is in Example 1 shown in Table 1, the status output signal generator 830 may simultaneously output a logic value corresponding to the acquired status number to the three output terminals based on the acquired status number. Here, when 3 is one of examples, the number of output terminals may be determined as a natural number greater than or equal to the number of log 2 status identification numbers. For example, when the acquired status number is 4, the status output signal generator 830 may simultaneously output a high level signal, a low level signal, and a low level signal to three output terminals.

According to another embodiment, when the status output value is set as shown in Example 2 of Table 1, the status output signal generator 830 may continuously output a logic value corresponding to the acquired status number to one output terminal. At this time, the number of logic values continuously output may be a natural value greater than or equal to the number of log 2 status identification numbers. For example, if the number of status identification numbers is 8, three logic values may be continuously output, and if the number is 15, four logic values may be continuously output. For example, if the acquired status number is 3, the status output signal generator 830 may continuously output a low level signal, a high level signal, and a high level signal to one output terminal. The width of each signal may be preset. For example, a signal width may be a width corresponding to one clock period, a width corresponding to two block periods, or a width corresponding to multiple clock periods.

According to another embodiment, when the status output value is set as Example 3 shown in Table 1, the status output signal generator 830 may output a high level signal (or a low level signal) to one output terminal so as to have the signal width corresponding to the based on the acquired status number. For example, if the acquired status number is 5, the status output signal generator 830 may output a high level signal (or a low level signal) with the width corresponding to 5 clock cycles to the one output terminal.

According to another embodiment, if the status output value is set as Example 4 shown in Table 1, the status output signal generator 830 may output a signal to one output terminal to have a signal size corresponding to the acquired status number. For example, if the acquired status number is 4, the status output signal generator 830 may output a signal with a voltage size of 1.2V to the one output terminal.

As described above, when the status output value is output through the output terminal, the user may monitor the status output value by using an oscilloscope or logic analyzer, and efficiently analyze or debug the performance of a device such as SoC or ASIC having performance clearly set based on changes in the status through the corresponding monitoring. In addition, based on the changes in the monitored status, the performance of software running on a general-purpose or multi-purpose processor may be analyzed in a short period of time or if there are any problems, the problems may be debugged.

Although the present embodiments have been described with reference to the exemplified drawings, it is to be understood that the present embodiments are not limited to the embodiments and drawings disclosed in this specification, and those skilled in the art will appreciate that various modifications are possible without departing from the scope and spirit of the present embodiments. Further, although the operating effects according to the configuration of the present embodiments are not explicitly described while describing an embodiment of the present embodiments, it should be appreciated that predictable effects are also to be recognized by the configuration.

What is claimed is:

1. A device performance analysis apparatus comprising:
a status detector configured to acquire a first status identification number stored by an analysis code embedded in a software configured to drive a device based on a preset parameter; and
a status output signal generator configured to output a first status output value corresponding to the first status identification number acquired by the status detector to outside,
wherein the first status output value is usable for analyzing or debugging performance of the device.

2. The device performance analysis apparatus of claim 1, further comprising:
a parameter setter configured to set a parameter for performance analysis of the device,
wherein the parameter setter is configured to set a status output value, to be output to the outside, corresponding to a status storage where a status identification number is stored by the analysis code and each of status identification numbers.

3. The device performance analysis apparatus of claim 2, wherein the status detector is configured to acquire the first status identification number by reading the status storage at preset intervals, or to acquire the first status identification number by reading the status storage based on an interrupt that occurs when the status identification number stored in the status storage changes.

4. The device performance analysis apparatus of claim 2, wherein the parameter setter is configured:
to set the number of the status identification numbers useable in the analysis code;
to set the number of output terminals, which is a natural value greater than or equal to the number of log 2 status identification numbers; and
to set the number of logic values distinct from each other, which is a natural value greater than or equal to the number of log 2 status identification numbers, as status output values corresponding to the respective status identification numbers,
wherein the status output signal generator is configured to simultaneously output the logic values corresponding to the first status identification number through the output terminals.

5. The device performance analysis apparatus of claim 2, wherein the parameter setter is configured:
to set the number of the status identification numbers that are useable in the analysis code;
to set the number of output terminals to ‘1’; and
to set the number of logic values distinct from each other, which is a natural value greater than or equal to the number of log 2 status identification numbers as status output values corresponding to the respective status identification numbers,
wherein the status output signal generator is configured to continuously output the logic values through the output terminals.

6. The device performance analysis apparatus of claim 2, wherein the parameter setter is configured:
to set the number of the status identification numbers useable in the analysis code;
to set the number of output terminals to ‘1’; and
to set signals with distinct widths from each other to be output as status output values corresponding to the respective status identification numbers,
wherein the status output signal generator is configured to output a signal with a width corresponding to the first status identification number through the output terminals.

7. The device performance analysis apparatus of claim 2, wherein the parameter setter is configured:
to set the number of the status identification numbers usable in the analysis code;
to set the number of output terminals to ‘1’; and
to set signals with distinct voltages from each other to be output as status output values corresponding to the respective status identification numbers,
wherein the status output signal generator is configured to output a signal with a voltage corresponding to the first status identification number through the output terminals.

8. A device comprising:
a processor configured to execute a software comprising an analysis code inserted into each of multiple positions within the software, with a status identification number as a parameter; and
an analysis tool configured to analyze performance of the software executed on the processor,
wherein when the analysis code is executed, the processor is configured to store a first status identification number, which is a parameter of the executed analysis code, in a status storage, and
the analysis tool is configured to acquire the first status identification number stored in the status storage and output a status output value corresponding to the first status identification number through an output terminal,
wherein the first status output value is usable for analyzing or debugging performance of the device.

9. The device of claim 8, wherein an analysis activation parameter is set in the software, and
when the analysis activation parameter is deactivated, the processor is configured not to execute the analysis code and when the analysis activation parameter is activated, the processor is configured to execute the analysis code.

10. The device of claim 8, wherein the analysis tool is configured to acquire the first status identification number by reading the status storage at preset intervals, or to acquire the first status identification number by reading the status storage based on an interrupt that occurs when the status identification number stored in the status storage changes.

11. The device of claim 8, wherein the analysis tool is configured:
to set the number of status identification numbers used in the analysis code as a parameter;
to set the number of output terminals, which is a natural value greater than or equal to the number of log 2 status identification numbers;
to set the number of logic values distinct from each other, which is a natural value greater than or equal to the number of log 2 status identification numbers, as a status output value corresponding to each of the status identification numbers; and
to output the logic values simultaneously, corresponding to the first status identification number, through the output terminals.

12. The device of claim 8, wherein the analysis tool is configured:
to set the number of status identification numbers that are useable in the analysis code;
to set the number of output terminals to ‘1’;
to set the number of logic values, which is a natural value greater than or equal to the number of log 2 status identification numbers as a status output value corresponding to each of the status identification numbers, and
status output signal generator to continuously output the logic values.

13. The device of claim 8, wherein the analysis tool is configured:
to set the number of the status identification numbers useable in the analysis code;
to set the number of output terminals to ‘1’;
to set widths of distinct signals from each other to be output as a status output value corresponding to each of the status identification numbers, and
status output signal generator to output a signal with a width corresponding to the first status identification number through the output terminal.

14. The device of claim 8, wherein the analysis tool is configured:
to set the number of the status identification numbers usable in the analysis code;
to set the number of output terminals to ‘1’;
to set voltages of distinct signals from each other to be output as a status output value corresponding to each of the status identification numbers, and
status output signal generator to output a signal with a voltage corresponding to the first status identification number through the output terminal.

15. A performance analysis method of a device comprising:
setting a parameter for performance analysis of the device;
acquiring a first status identification number stored by an analysis code inserted in a software configured to drive the device based on the parameter; and
outputting a first status output value corresponding to the first status identification number to outside,
wherein the first status output value is usable for analyzing or debugging performance of the device.

16. The performance analysis method of the device of claim 15, wherein the setting the parameter for the performance analysis of the device comprises,
setting a status storage where a status identification number is stored by the analysis code; and
setting a status output value corresponding to each of multiple status identification numbers to be output to the outside.

17. The performance analysis method of the device of claim 16, wherein the acquiring the first status identification number comprises,
acquiring the first status identification number by reading the status storage at preset intervals; or
acquiring the first status identification number by reading the status storage based on an interrupt that occurs when the status identification number stored in the status storage changes.

18. The performance analysis method of the device of claim 15, wherein the setting the parameter for the performance analysis of the device comprises,
setting the number of status identification numbers;
setting the number of output terminals, which is a natural value greater than or equal to the number of log 2 status identification numbers); and
setting the number of logic values, which is a natural value greater than or equal to the number of log 2 status identification numbers, and
the outputting the first status identification number to the outside comprises,
simultaneously outputting the logic values, corresponding to the first status identification number, through the output terminals.

19. The performance analysis method of the device of claim 15, wherein the setting the parameter for the performance analysis of the device comprises,
setting the number of status identification numbers;
setting the number of output terminals to ‘1’; and
setting the number of logic values distinct from each other, which is a natural value greater than or equal to the number of log 2 status identification numbers, and
the outputting the first status output value corresponding to the first status identification number to the outside comprises,
continuously outputting the logic values corresponding to the first state identification number through the output terminals.

20. The performance analysis method of the device of claim 15, wherein the setting the parameter for the performance analysis of the device comprises,
setting the number of status identification numbers;
setting the number of output terminals to ‘1’; and
setting signals with distinct widths from each other to be output as status output values corresponding to the respective status identification numbers, and
the outputting the first status output value corresponding to the first status identification number to the outside comprises,
outputting a signal with a width corresponding to the first status identification number through the output terminals.

21. The performance analysis method of the device of claim 15, wherein the setting the parameter for the performance analysis of the device comprises,
setting the number of status identification numbers;
setting the number of output terminals to ‘1’; and
setting signals with distinct voltage from each other to be output as status output values corresponding to the respective status identification numbers, and
the outputting the first status output value corresponding to the first status identification number to the outside comprises,
outputting a signal with a voltage corresponding to the first status identification number through the output terminals.
